(19) United States
(12) Patent Application Publication
(10) Pub. No.: US 2024/0410124 A1
(43) Pub. Date: Dec. 12, 2024

(54) Snow Removal Assembly

(71) Applicant: Steven Davis, Chicago, IL (US)

(72) Inventor: Steven Davis, Chicago, IL (US)

(21) Appl. No.: 18/207,559

(22) Filed: Jun. 8, 2023

(51) Int. Cl. E01H 10/00; B60Q 1/18; B60Q 1/22; B60R 1/26; B62D 63/04; E01H 5/06

(52) U.S. Cl. CPC E01H 10/007; B60Q 1/18; B60Q 1/22; B60R 1/26; B62D 63/04; E01H 5/061; E01H 5/065; B60R 2300/8066

(57) ABSTRACT

A snow removal assembly for removing snow from a driveway includes a vehicle that has a cab and a plurality of wheels. The vehicle has a pair of doors each hingedly attached to the cab and each of the doors pivots vertically on the cab when the doors are opened. A snow plow is movably attached to the vehicle thereby facilitating the snow plow to push snow from a driveway when the vehicle is driven on the roadway. Additionally, the snow plow is positionable at a variety of angles on the vehicle thereby facilitating the snow plow to push the snow in a chosen direction on the driveway. A salt spreader is attached to the vehicle and the salt spreader contains granular salt. The salt spreader releases the granular salt onto the driveway when the salt spreader is turned on to inhibit the formation of ice on the driveway.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to snow removal devices and more particularly pertains to a new snow removal device for removing snow from a driveway. The device includes a vehicle that has a cab which includes a pair of gull wing doors that pivot vertically when the gull wing doors are opened. The device includes a snow plow that is pivotally mounted to a front of the vehicle and a snow plow motor which moves the snow plow back and forth. The device includes a salt spreader that is mounted to a rear of the vehicle for spreading granular salt along the driveway.

### (2) Description of Related Art Including Information Disclosed Under 37 CFR 1.97 and 1.98

The prior art relates to snow removal devices including a variety of cab devices that is attachable to a snow blower. The prior art discloses a snow blower that is attachable to a front end of an all terrain vehicle. The prior art discloses a snow blower device that includes a self propelled snow blower and a canopy that is attached to the self propelled snow blower for surrounding a driver. The prior art discloses a combination snow blower and snow plow device that includes a snow plow mounted to an intake chute of a snow blower.

### BRIEF SUMMARY OF THE INVENTION

An embodiment of the disclosure meets the needs presented above by generally comprising a vehicle that has a cab and four wheels. The vehicle has a pair of doors each hingedly attached to the cab and each of the doors pivots vertically on the cab when the doors are opened. A snow plow is movably attached to the vehicle thereby facilitating the snow plow to push snow from a driveway when the vehicle is driven on the roadway. Additionally, the snow plow is positionable at a variety of angles on the vehicle thereby facilitating the snow plow to push the snow in a chosen direction on the driveway. A salt spreader is attached to the vehicle and the salt spreader contains granular salt. The salt spreader releases the granular salt onto the driveway when the salt spreader is turned on to inhibit the formation of ice on the driveway.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a snow removal assembly according to an embodiment of the disclosure.

FIG. 2 is a back perspective view of an embodiment of the disclosure.

FIG. 3 is a cross sectional view taken along line 3-3 of FIG. 2 of an embodiment of the disclosure.

FIG. 4 is a right side perspective view of an embodiment of the disclosure.

FIG. 5 is a top view of an embodiment of the disclosure.

FIG. 6 is a schematic view of an embodiment of the disclosure.

FIG. 7 is a left side view of an embodiment of the disclosure.

### DETAILED DESCRIPTION OF THE INVENTION

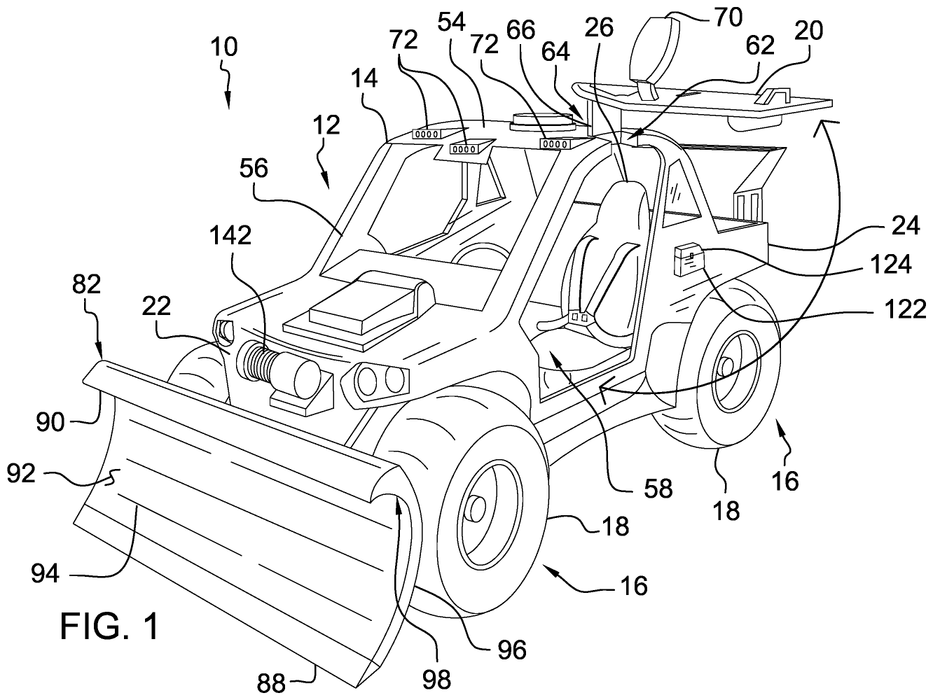

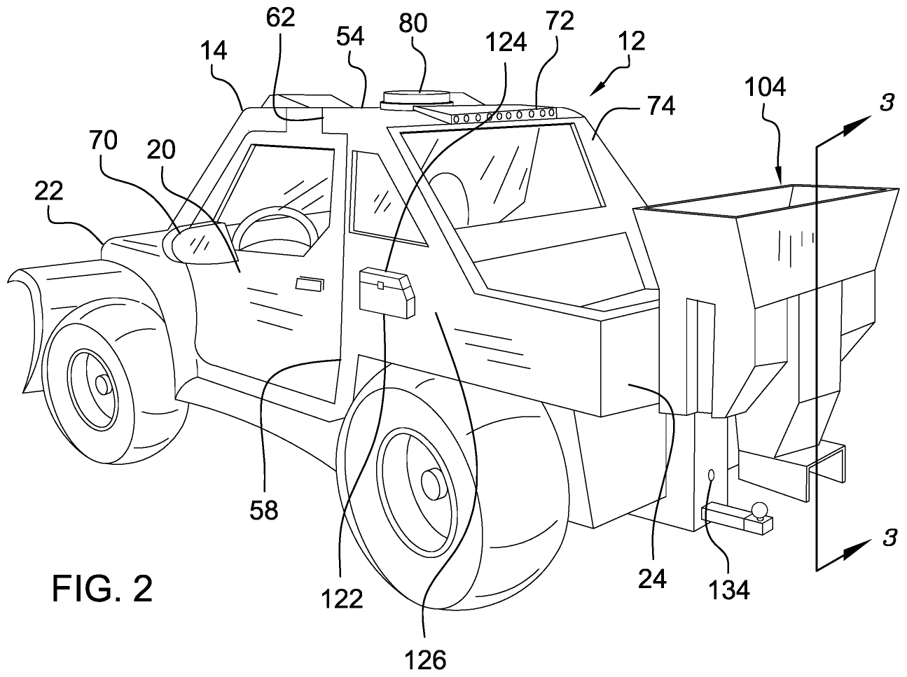

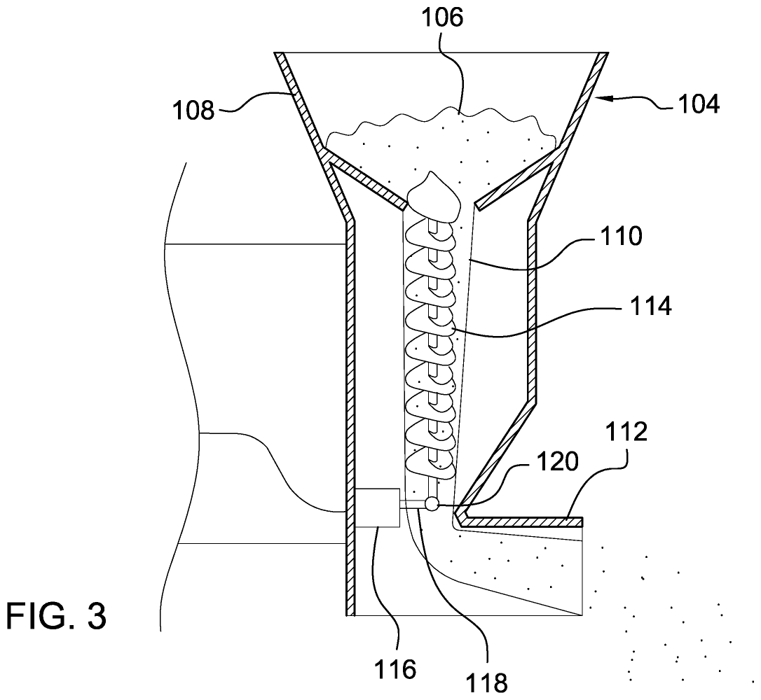

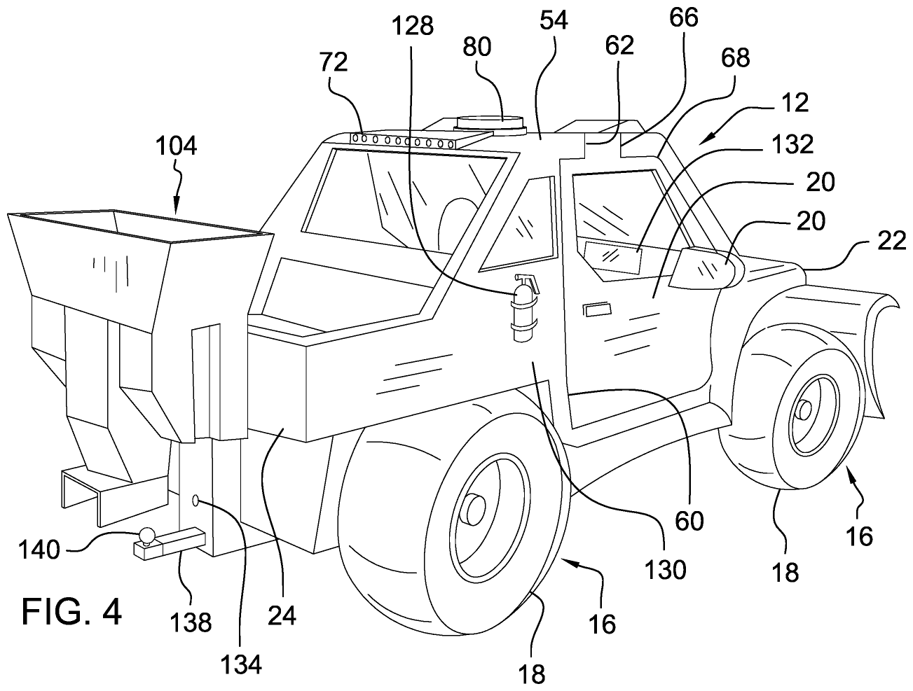

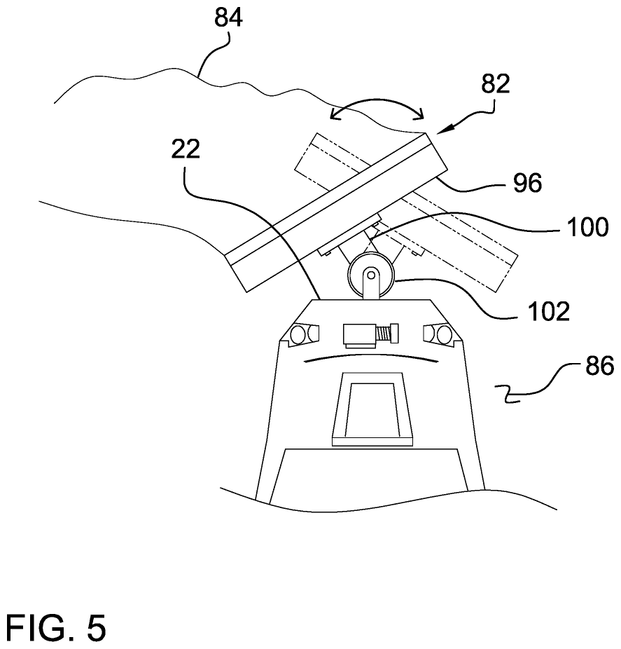

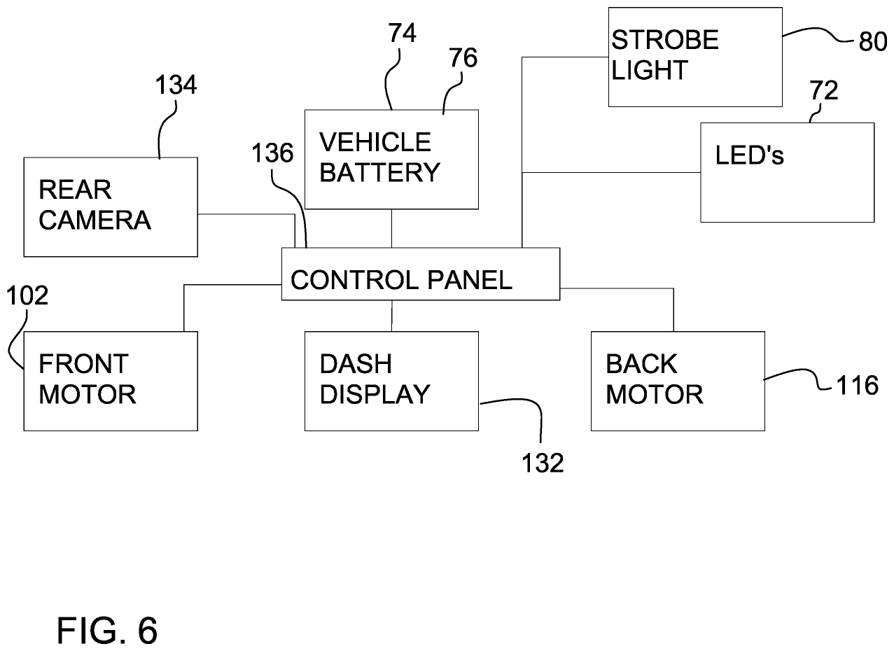

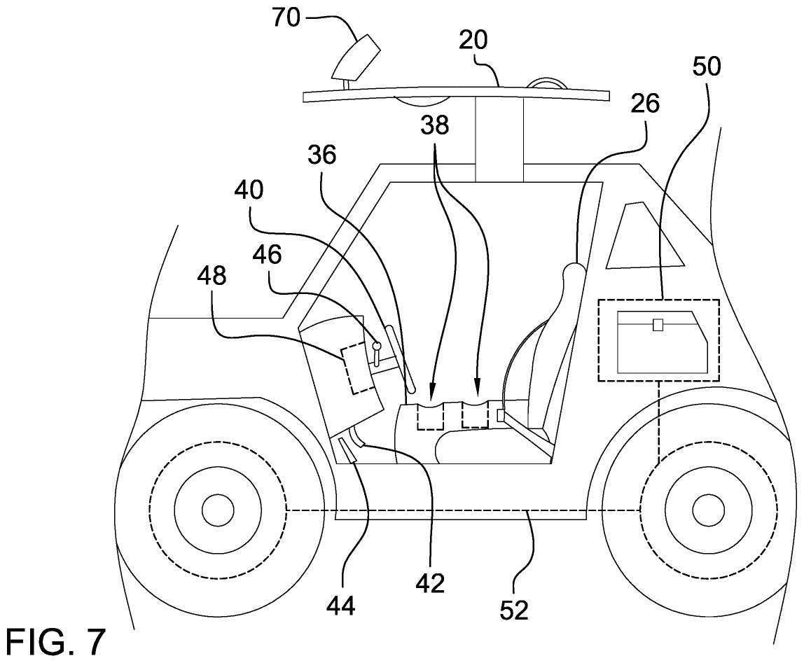

With reference now to the drawings, and in particular to FIGS. 1 through 7 thereof, a new snow removal device embodying the principles and concepts of an embodiment of the disclosure and generally designated by the reference numeral 10 will be described.

As best illustrated in FIGS. 1 through 7, the snow removal assembly 10 generally comprises a vehicle 12 that has a cab 14 and a plurality of wheels 16. The wheels 16 may include inflatable, all terrain rubber tires 18 that might have an overall diameter of approximately 80.0 cm. The vehicle 12 has a pair of doors 20 that is each hingedly attached to the cab 14 and each of the doors 20 pivots vertically on the cab 14 when the doors 20 are positioned in an open position. Thus, the doors 20 function in the convention of gull wing doors commonly associated with sports cars. The vehicle 12 has a front end 22 and a rear end 24 and a body of the vehicle 12 may be structured to have the ornamental appearance of a side by side utility vehicle commonly employed for off road recreational purposes.

The vehicle 12 has a driver's seat 26 that is positioned within the cab 14 and the driver's seat 26 includes a safety harness 28 which comprises a pair of lap belts 30 and a pair of shoulder belts 32. The lap belts 30 and the shoulder belts 32 are matable to each other to form a criss-cross pattern for securing a driver 34 to the driver's seat 26. The vehicle 12 has a console 36 that is located adjacent to the driver's seat 26 and the console 36 has a pair of cup holders 38 each recessed in to the console 36. The vehicle 12 includes a steering wheel 40, a gas pedal 42, a brake pedal 44, a turn signal lever 46, a heater 48 for heating the cab 14 and other accessories commonly associated with motorized vehicles that are driven on public roadways. Furthermore, the vehicle 12 has an internal combustion engine 50 of an appropriate size and design and a drive train 52 that is conventional to utility vehicles for supplying power to drive the vehicle 12.

The cab 14 has a roof 54, a windshield 56, a first entry 58 and a second entry 60. The roof 54 has a pair of cut outs 62 each aligned with a respective one of the first entry 58 and the second entry 60. Each of the doors 20 has a hinge 64 that is located in a respective one of the cut outs 62. The hinge 64 on each of the doors 20 includes a member 66 that is attached to an upper edge 68 of a respective one of the doors 20. The member 66 is perpendicularly oriented with the respective door 20 such that the respective door 20 lies on a horizontal plane when the respective door 20 is opened. Additionally, each of the doors 20 may include a rear view mirror 70.

A plurality of light emitters 72 is each attached to the cab 14 of the vehicle 12 to emit light outwardly from the cab 14. Respective ones of the light emitters 72 are positioned on the roof 54 of the cab 14 at a point located over the windshield 56 to illuminate an area in front of the vehicle 12. Respective ones of the light emitters 72 are positioned on the roof 54 of the cab 14 at a point located at a rear side 74 of the cab 14 to illuminate an area behind the vehicle 12. Each of the light emitters 72 is electrically coupled to a power source 76 comprising an electrical system 78 of the vehicle 12. Additionally, each of the light emitters 72 may comprise a light bar equipped with a plurality of light emitting diodes or other type of high intensity lighting equipment.

A strobe light 80 is attached to the roof 54 of the cab 14 and the strobe light 80 sequentially turns on and off when the strobe light 80 is actuated. In this way the strobe light 80 can visually communicate a caution signal. The strobe light 80 is electrically coupled to the power source 76 comprising the electrical system 78 of the vehicle 12. The strobe light 80 may comprise a light emitting diode or other type of electronic light emitter. In an alternative embodiment, the vehicle may have a bed extending rearwardly from the cab and the vehicle may have a pair of rear axles each with a pair of rear wheels for a total of six wheels. It would be understood that similar vehicle variations can be provided with different numbers of total wheels, or tracks or the like.

A snow plow 82 is movably attached to the vehicle 12 thereby facilitating the snow plow 82 to push snow 84 from a driveway 86 when the vehicle 12 is driven on the driveway 86. The snow plow 82 is positionable at a variety of angles on the vehicle 12 thereby facilitating the snow plow 82 to push the snow 84 in a chosen direction on the driveway 86. The snow plow 82 has a lower edge 88, an upper edge 90 and an outer surface 92 extending between the lower edge 88 and the upper edge 90. The outer surface 92 has a front side 94 and a back side 96 and the front side 94 is concavely arcuate between the lower edge 88 and the upper edge 90 thereby enhancing the snow 84 to travel upwardly along the snow plow 82 when the snow plow 82 pushes the snow 84. The front side 94 has a curve 98 positioned adjacent to the upper edge 90 which has a radius of curvature that is less than a radius of curvature of the front side 94 between the curve 98 and the lower edge 88. In this way the upper edge 90 is directed downwardly toward the lower edge 88 such that the curve 98 inhibits the snow 84 from passing over the snow plow 82 when the snow plow 82 pushes the snow 84.

The snow plow 82 includes a pivot 100 extending away from the back side 96 of the outer surface 92 and the pivot 100 is centrally positioned along a width of the snow plow 82. A plow motor 102 is disposed on the front end 22 of the vehicle 12 and the plow motor 102 engages the pivot 100 on the back side 96 of the outer surface 92 of the snow plow 82. The plow motor 102 rotates in a first direction or a second direction and the plow motor 102 has an axis of rotation that is perpendicularly oriented with the pivot 100. The snow plow 82 is angled to the left on the vehicle 12 when the plow motor 102 rotates in the first direction and the snow plow 82 is angled to the right on the vehicle 12 when the plow motor 102 rotates in the second direction. The plow motor 102 is electrically coupled to the power source 76 comprising the electrical system 78 of the vehicle 12 and the plow motor 102 may comprise an electric motor or the like.

A salt spreader 104 is attached to the vehicle 12 and the salt spreader 104 contains granular salt 106. The salt spreader 104 releases the granular salt 106 onto the driveway 86 when the salt spreader 104 is turned on to inhibit the formation of ice on the driveway 86. The salt spreader 104 includes a hopper 108, a chute 110 that is in fluid communication with the hopper 108 and a dispensing nozzle 112 that is in fluid communication with the chute 110. The salt spreader 104 includes an auger 114 that is rotatably disposed within the chute 110 and the auger 114 extends between the hopper 108 and the dispensing nozzle 112.

The auger 114 urges granular salt 106 downwardly through the chute 110 and outwardly through the dispensing nozzle 112 when the auger 114 is turned on. The salt spreader 104 includes an auger motor 116 that is positioned within the salt spreader 104 and the auger motor 116 has an output shaft 118 which engages a lower end 120 of the auger 114. The output shaft 118 is perpendicularly oriented with the auger 114 and the output shaft 118 rotates in a first direction when the auger motor 116 is turned on thereby rotating the auger 114. The auger motor 116 is electrically coupled to the power source 76 comprising the electrical system 78 of the vehicle 12. Additionally, the auger motor 116 may comprise an electric motor or the like.

A tool box 122 is attached to the cab 14 of the vehicle 12 and the tool box 122 includes a lid 124 that is hingedly disposed on the tool box 122 for opening and closing the tool box 122. The tool box 122 is positioned on a first lateral side 126 of the cab 14 and the tool box 122 is located behind a respective one of the doors 20. A fire extinguisher 128 is removably attached to the cab 14 of the vehicle 12 and the fire extinguisher 128 is positioned on a second lateral side 130 of the cab 14. The fire extinguisher 128 is located behind a respective one of the doors 20 and the fire extinguisher 128 may comprise an ABC powder fire extinguisher.

A display 132 is positioned within the cab 14 of the vehicle 12 and the display 132 is positioned in a conspicuous location in the vehicle 12 thereby enhancing visibility of the display 132 for the driver 34. The display 132 is electrically coupled to the power source 76 comprising the electrical system 78 of the vehicle 12. Additionally, the display 132 may comprise a liquid crystal display or other type of electronic display. A rear view camera 134 is disposed on the rear end 24 of the vehicle 12 thereby facilitating the rear view camera 134 to capture imagery of the area behind the vehicle 12. The rear view camera 134 is electrically coupled to the display 132 thereby facilitating the display 132 to display imagery captured by the rear view camera 134 to facilitate the driver 34 to see behind the vehicle 12 when the vehicle 12 is backing. The rear view camera 134 may comprise a digital video camera or the like.

A control panel 136 is positioned in the cab 14 and the control panel 136 is electrically coupled to the plow motor 102, the auger motor 116, each of the light emitters 72, the strobe light 80, the display 132 and the rear view camera 134. The control panel 136 may comprise a touch screen display which displays a plurality of control icons. The control panel 136 may include a plurality of control buttons or any other type of electronic control. A tow hitch 138 is coupled to and extends rearwardly from the rear end 24 of the vehicle 12 and the tow hitch 138 includes a ball 140 for engaging a trailer hitch of a trailer for towing the trailer with the vehicle 12. An electric winch 142 is attached to the front end 22 of the vehicle 12.

In use, the vehicle 12 is driven during winter months to remove snow 84 from the driveway 86 or other area where motorized vehicles are driven or parked. The plow motor 102 is actuated to position the snow plow 82 at a desired angle to push snow 84 off of the driveway 86. Furthermore, the snow plow 82 can be adjusted at any time while the vehicle 12 is being driven. The salt spreader 104 can be turned on at any time to spread granular salt 106 onto the driveway 86 thereby inhibiting the formation of ice on the driveway 86. In this way the driveway 86 can be cleared of snow 84 and ice while the driver 34 is kept warm and comfortable in the cab 14. Furthermore, the driver 34 is not required to physically exert themselves while clearing the driveway 86 of snow 84 and ice. In this way physically limited drivers can effectively and efficiently maintain the driveway 86 in winter months.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A snow removal assembly for removing snow from a driveway and applying salt to inhibit the formation of ice, said assembly comprising:
a vehicle having a cab and a plurality of wheels, said vehicle having a pair of doors each being hingedly attached to said cab, each of said doors pivoting vertically on said cab when said doors are positioned in an open position;
a plurality of light emitters, each of said light emitters being attached to said cab of said vehicle wherein each of said light emitters is configured to emit light outwardly from said cab;
a strobe light being attached to said roof of said cab, said strobe light sequentially turning on and off when said strobe light is actuated wherein said strobe light is configured to visually communicate a caution signal;
a snow plow being movably attached to said vehicle thereby facilitating said snow plow to push snow from a driveway when said vehicle is driven on the roadway, said snow plow being positionable at a variety of angles on said vehicle thereby facilitating said snow plow to push the snow in a chosen direction on the driveway; and
a salt spreader being attached to said vehicle, said salt spreader containing granular salt, said salt spreader releasing the granular salt onto the driveway when said salt spreader is turned on to inhibit the formation of ice on the driveway.

2. The assembly according to claim 1, wherein:
said vehicle has a front end and a rear end, said vehicle having a driver's seat being positioned within said cab;
said driver's seat includes a safety harness comprising a pair of lap belts and a pair of shoulder belts, said lap belts and said shoulder belts being matable to each other to form a criss-cross pattern for securing a driver to said driver's seat;
said vehicle has a console being located adjacent to said driver's seat, said console having a pair of cup holders each being recessed in to said console;
said cab has a roof and a windshield and a first entry and a second entry, said roof having a pair of cut outs each being aligned with a respective one of said first entry and said second entry; and
each of said doors has a hinge being located in a respective one of said cut outs, said hinge on each of said doors including a member being attached to an upper edge of a respective one of said doors, said member being perpendicularly oriented with said respective door such that said respective door lies on a horizontal plane when said respective door is opened.

3. The assembly according to claim 2, wherein respective ones of said light emitters is positioned on said roof of said cab at point located over said windshield wherein said light emitters over said windshield is configured to illuminate an area in front of said vehicle, respective ones of said light emitters being positioned on said roof of said cab at a point located at a rear side of said cab wherein each of said light emitters on said rear side are configured to illuminate an area behind said vehicle, each of said light emitters being electrically coupled to a power source comprising an electrical system of said vehicle.

4. The assembly according to claim 1, wherein said snow plow has a lower edge, an upper edge and a outer surface extending between said lower edge and said upper edge, said outer surface having a front side and a back side, said front side being concavely arcuate between said lower edge and said upper edge thereby enhancing the snow to travel upwardly along the snow plow when said snow plow pushes the snow, said front side having a curve positioned adjacent to said upper edge which has a radius of curvature being less than a radius of curvature of said front side between said curve and said lower edge such that said upper edge is directed downwardly toward said lower edge such that said curve inhibits the snow from passing over said snow plow when said snow plow pushes the snow, said snow plow including a pivot extending away from said back side of said outer surface, said pivot being centrally positioned along a width of said snow plow.

5. The assembly according to claim 4, further comprising a plow motor being disposed on a front end of said vehicle, said plow motor engaging said pivot on said back side of said outer surface of said snow plow, said plow motor rotating in a first direction or a second direction, said plow motor having an axis of rotation being perpendicularly oriented with said pivot, said snow plow being angled to the left on said vehicle when said plow motor rotates in said first direction, said snow plow being angled to the right on said vehicle when said plow motor rotates in said second direction, said plow motor being electrically coupled to said power source comprising said electrical system of said vehicle.

6. The assembly according to claim 1, wherein:
said salt spreader includes a hopper and a chute being in fluid communication with said hopper and a dispensing nozzle being in fluid communication with said chute;
said salt spreader includes an auger being rotatably disposed within said chute, said auger extending between said hopper and said dispensing nozzle, said auger urging salt downwardly through said chute and outwardly through said dispensing nozzle when said auger is turned on;
said salt spreader includes an auger motor being positioned within said salt spreader, said auger motor having an output shaft engaging a lower end of said auger, said output shaft being perpendicularly oriented with said auger, said output shaft rotating in a first direction when said auger motor is turned on thereby rotating said auger; and
said auger motor being electrically coupled to a power source comprising an electrical system of said vehicle.

7. The assembly according to claim 1, further comprising:
a tool box being attached to said cab of said vehicle, said tool box including a lid being hingedly disposed on said tool box for opening and closing said tool box, said tool box being positioned on a first lateral side of said cab, said tool box being located behind a respective one of said doors; and
a fire extinguisher being removably attached to said cab of said vehicle, said fire extinguisher being positioned on a second lateral side of said cab, said fire extinguisher being located behind a respective one of said doors.

8. The assembly according to claim 1, further comprising:
a display being positioned within said cab of said vehicle, said display being positioned in a conspicuous location in said vehicle thereby enhancing visibility of said display for a driver, said display being electrically coupled to said power source comprising said electrical system of said vehicle; and
a rear view camera being disposed on said rear end of said vehicle thereby facilitating said rear view camera to capture imagery of the area behind said vehicle, said rear view camera being electrically coupled to said display thereby facilitating said display to display imagery captured by said rear view camera wherein said rear view camera is configured to facilitate the driver to see behind said vehicle when the vehicle is backing.

9. A snow removal assembly for removing snow from a driveway and applying salt to inhibit the formation of ice, said assembly comprising:
a vehicle having a cab and a plurality of wheels, said vehicle having a pair of doors each being hingedly attached to said cab, each of said doors pivoting vertically on said cab when said doors are positioned in an open position, said vehicle having a front end and a rear end, said vehicle having a driver's seat being positioned within said cab, said driver's seat including a safety harness comprising a pair of lap belts and a pair of shoulder belts, said lap belt and said shoulder belts being matable to each other to form a criss-cross pattern for securing a driver to said driver's seat, said vehicle having a console being located adjacent to said driver's seat, said console having a pair of cup holders each being recessed in to said console, said cab having a roof and a windshield and a first entry and a second entry, said roof having a pair of cut outs each being aligned with a respective one of said first entry and said second entry, each of said doors having a hinge being located in a respective one of said cut outs, said hinge on each of said doors including a member being attached to an upper edge of a respective one of said doors, said member being perpendicularly oriented with said respective door such that said respective door lies on a horizontal plane when said respective door is opened;
a plurality of light emitters, each of said light emitters being attached to said cab of said vehicle wherein each of said light emitters is configured to emit light outwardly from said cab, respective ones of said light emitters being positioned on said roof of said cab at point located over said windshield wherein said light emitters over said windshield is configured to illuminate an area in front of said vehicle, respective ones of said light emitters being positioned on said roof of said cab at a point located at a rear side of said cab wherein each of said light emitters on said rear side are configured to illuminate an area behind said vehicle, each of said light emitters being electrically coupled to a power source comprising an electrical system of said vehicle;
a strobe light being attached to said roof of said cab, said strobe light sequentially turning on and off when said strobe light is actuated wherein said strobe light is configured to visually communicate a caution signal, said strobe light being electrically coupled to said power source comprising said electrical system of said vehicle;
a snow plow being movably attached to said vehicle thereby facilitating said snow plow to push snow from a driveway when said vehicle is driven on the roadway, said snow plow being positionable at a variety of angles on said vehicle thereby facilitating said snow plow to push the snow in a chosen direction on the driveway, said snow plow having a lower edge, an upper edge and a outer surface extending between said lower edge and said upper edge, said outer surface having a front side and a back side, said front side being concavely arcuate between said lower edge and said upper edge thereby enhancing the snow to travel upwardly along the snow plow when said snow plow pushes the snow, said front side having a curve positioned adjacent to said upper edge which has a radius of curvature being less than a radius of curvature of said front side between said curve and said lower edge such that said upper edge is directed downwardly toward said lower edge such that said curve inhibits the snow from passing over said snow plow when said snow plow pushes the snow, said snow plow including a pivot extending away from said back side of said outer surface, said pivot being centrally positioned along a width of said snow plow;
a plow motor being disposed on said front end of said vehicle, said plow motor engaging said pivot on said back side of said outer surface of said snow plow, said plow motor rotating in a first direction or a second direction, said plow motor having an axis of rotation being perpendicularly oriented with said pivot, said snow plow being angled to the left on said vehicle when said plow motor rotates in said first direction, said snow plow being angled to the right on said vehicle when said plow motor rotates in said second direction, said plow motor being electrically coupled to said power source comprising said electrical system of said vehicle;
a salt spreader being attached to said vehicle, said salt spreader containing granular salt, said salt spreader releasing the granular salt onto the driveway when said salt spreader is turned on to inhibit the formation of ice on the driveway, said salt spreader including a hopper and a chute being in fluid communication with said hopper and a dispensing nozzle being in fluid communication with said chute, said salt spreader including an auger being rotatably disposed within said chute, said auger extending between said hopper and said dispensing nozzle, said auger urging salt downwardly through said chute and outwardly through said dispensing nozzle when said auger is turned on, said salt spreader including an auger motor being positioned within said salt spreader, said auger motor having an output shaft engaging a lower end of said auger, said output shaft being perpendicularly oriented with said auger, said output shaft rotating in a first direction when said auger motor is turned on thereby rotating said auger, said auger motor being electrically coupled to said power source comprising said electrical system of said vehicle;
a tool box being attached to said cab of said vehicle, said tool box including a lid being hingedly disposed on said tool box for opening and closing said tool box, said tool box being positioned on a first lateral side of said cab, said tool box being located behind a respective one of said doors;
a fire extinguisher being removably attached to said cab of said vehicle, said fire extinguisher being positioned on a second lateral side of said cab, said fire extinguisher being located behind a respective one of said doors;
a display being positioned within said cab of said vehicle, said display being positioned in a conspicuous location in said vehicle thereby enhancing visibility of said display for a driver, said display being electrically coupled to said power source comprising said electrical system of said vehicle;
a rear view camera being disposed on said rear end of said vehicle thereby facilitating said rear view camera to capture imagery of the area behind said vehicle, said rear view camera being electrically coupled to said display thereby facilitating said display to display imagery captured by said rear view camera wherein said rear view camera is configured to facilitate the driver to see behind said vehicle when the vehicle is backing; and
a tow hitch being coupled to and extending rearwardly from said rear end of said vehicle, said tow hitch including a ball for engaging a trailer hitch of a trailer for towing the trailer with said vehicle.
